(19) United States
(12) Patent Application Publication
(10) Pub. No.: US 2025/0206890 A1
(43) Pub. Date: Jun. 26, 2025

(54) SYNTHESIS OF BIODEGRADABLE MELANOIDIN POLYMERS USING A CONTROLLED MAILLARD REACTION

(71) Applicant: One Idea LLC, Merced, CA (US)

(72) Inventor: Juan P. Russi, Buenos Aires (AR)

(73) Assignee: One Idea LLC, Merced, CA (US)

(21) Appl. No.: 19/078,952

(22) Filed: Mar. 13, 2025

Related U.S. Application Data
(63) Continuation-in-part of application No. PCT/US23/73843, filed on Sep. 11, 2023.
(60) Provisional application No. 63/375,419, filed on Sep. 13, 2022.

(51) Int. Cl. C08H 1/00

(52) U.S. Cl. CPC C08H 1/00

(57) ABSTRACT

Biodegradable melanoidin polymers of varying solubility prepared from non-fossil fuel-based ingredients by a method that includes at least the following steps:
a) mixing by application of shear force a quantity of a reducing carbohydrate source and a quantity of an amino group-containing compound to provide a mixture, wherein neither the carbohydrates nor the amino acid group compounds are isolated from fossil fuels;
b) heating the mixture for a sufficient amount of time at a sufficient temperature and pressure with sufficient moisture so that a Maillard reaction occurs between the amino groups and the reducing carbohydrate source provides a Maillard reaction product that will effectively yield a bioplastic;
c) stopping the reaction before it proceeds significantly beyond the melanoidin-formation steps of the Maillard reaction to limit the formation of acrylamides; and
d) vacuum-dehydrating the bioplastic reaction product under reduced pressure.

Compositions prepared by the disclosed methods are also provided.

### CROSS-REFERENCE TO RELATED APPLICATIONS

This application is a continuation in part of International Patent Application No. PCT/US2023/073843, filed on Sep. 11, 2023, which is entitled to priority pursuant to 35 U.S.C. § 119(e) to U.S. Provisional Patent No. 63/375,419, filed on Sep. 13, 2022. Each disclosure is incorporated herein by reference in its entirety.

### FIELD OF THE INVENTION

The present invention relates to generating biodegradable plastics derived from reducing carbohydrates and various amino group-containing compounds by subjecting these compounds to a controlled Maillard reaction. Moreover, this invention encompasses the utilization of bioplastic as a viable feed option for ruminants and biodigesters, which serves as a dual-purpose source for energy and protein.

### BACKGROUND OF THE INVENTION

Increasing global plastic waste levels represent a serious global pollution challenge requiring innovative solutions. Alternative, non-fossil-fuel-based plastics can be generated through novel applications and control of the Maillard reaction.

Manufactured (synthetic) plastics are designed to mimic the properties of natural materials. Plastics are prepared from polymers through either the conversion of natural products or synthesis from primary fossil-fuel-based compounds, such as oil, natural gas, or coal.

Alternative-source, bio-based plastics are becoming increasingly popular. Plastic products generated from biological feedstocks instead of fossil-fuel-based sources have demonstrated similar performance characteristics as fossil-fuel-based plastics. Bioplastics generated from Maillard reaction products have generated particular interest because they can be produced using inexpensive and sustainable raw materials.

Most plastics are based on hydrocarbons derived from fossil fuels, particularly oil; about 92% of these are thermoplastics. Plant-based and food industry waste-based plastics with reducing carbohydrates and amino groups generated via the Maillard reaction represent beneficial alternatives.

The Maillard reaction occurs in three stages. In the initial stage, which is reversible, a colorless product, without absorption of ultraviolet light (about 280 nm) is produced through two reactions: sugar-amine condensation and Amadori rearrangement. Following Strecker degradation in the intermediate stage, the final stage results in the formation of heterocyclic nitrogen compounds (melanoidins), which are subsequently turned into acrylamides. However, these processes are difficult to control and prevent from proceeding too far beyond melanoidin formation. Thus, there is a need for a simple, reliable, and controllable Maillard process to manufacture bioplastics with superior degradation properties compared to fossil fuel-based plastics.

### SUMMARY OF THE INVENTION

In one aspect, provided is a method of preparing biodegradable melanoidin polymers of varying solubilities from non-fossil fuel derived ingredients. In one embodiment, all of the raw materials used in a bioplastic can be incorporated into the diet of ruminants or fermented to produce methane in biodigesters, providing a sustainable disposal method for the bioplastic after its use.

In one embodiment, biodegradable plastics are generated using an extruder (variably at over atmospheric and below atmospheric pressures) to control a Maillard reaction between the amino groups of any protein or polypeptide, such as urea, feather meal, hydrolyzed wool or blood meal, and a reducing sugar or a reducing carbohydrate source.

In one aspect, provided is a method of preparing biodegradable melanoidin polymers of varying solubilities from non-fossil fuel derived ingredients, including at least the steps of:
a) mixing by application of shear force a quantity of a reducing carbohydrate source and a quantity of an amino group-containing compound to provide a mixture of said reducing carbohydrate source and amino group compounds, wherein neither the carbohydrates nor the amino acid group compounds are isolated from fossil fuels;
b) heating the mixture for a sufficient amount of time at a sufficient temperature and pressure with sufficient moisture so that a Maillard reaction occurs between the amino groups and the reducing carbohydrate source sufficient to provide a Maillard reaction product that will effectively yield a biodegradable bioplastic;
c) stopping the reaction before it proceeds significantly beyond the melanoidin-formation steps of the Maillard reaction to limit the formation of acrylamides; and
d) vacuum-dehydrating the bioplastic reaction product under reduced (sub-atmospheric) pressure.

In one embodiment, the method further comprises adding a quantity of alcohol to the mixture of step a). In a further embodiment, the alcohol is added to the mixture of said reducing carbohydrate source and amino group compounds at a ratio of about 5:95, about 10:90 or about 30:70.

In one embodiment, the bioplastic can be fed to ruminant animals or biodigesters.

In one embodiment, the quantity of the reducing carbohydrate source is less than the quantity of the amino group-containing compound. In one embodiment, the quantity of the reducing carbohydrate source is greater than the quantity of the amino group-containing compound. In one embodiment, the quantity of the reducing carbohydrate source and the amino group-containing compound is in an amount by weight.

In one embodiment, the amino group-containing compound comprises an amino acid, protein, urea, fatty amine, or other suitable nitrogen source.

In one embodiment, the amino group-containing compound comprises keratin (such as that found in feather meal or wool) to harden the bioplastic.

The present invention includes methods according to which the product of the present invention is made, as well as products made by the inventive method.

In one embodiment, the reducing carbohydrate source comprises hydrolyzed lactose permeate, fructose, sucrose, high fructose corn syrup, glucose, lactose, molasses, xylose, dextrose, maltodextrin, spent sulfite liquor, any other polysaccharides that can react with an amino group on an emulsifier, or mixtures of two or more thereof. In one embodiment, the reducing carbohydrate source can be present in emulsifiers that use polysaccharides as their reactive agent.

In one embodiment, the mixture is heated to a temperature between about 60° C. and about 135° C., or between about 60° C. and about 120° C., or between about 60° C. and about 80° C. In one embodiment, the pressure during heating can be between about 1 and 100 atm; the pressure during dehydration can be between about 0.4 atm and about 0.9 atm, or between about 0.4 atm and about 0.6 atm, or between about 0.4 atm and about 0.5 atm. In one embodiment, the mixture is heated at reduced pressure below 1 atm.

The mixture heating time can vary from about 0.25 minutes to about 240 minutes depending on the temperature and pressure used and the quantity of reactants relative to the reactor configuration.

In one embodiment, the ratio of the reducing carbohydrate source to the amino group-containing compound is selected from one of the following weight ratios: about 1:99, about 10:90, about 20:80, about 30:70, about 40:60, about 45:55, or about 50:50, or about 95:5, which will depend on the molecular weights of the reducing carbohydrate source and the amino group-containing compound used as well as the number of reactive amino group(s) in the amino group-containing compound(s) used in the reaction.

Different amounts of alcohols can be used to add rigidity to the bioplastic product. In particular, alcohols can be added to the amino group and reactive carbohydrate mix at a ratio of about 5:95, about 10:90 or about 30:70.

The method of preparing the biodegradable plastic can comprise a reactor or an extruder used like a biochemical reactor to accelerate the Maillard reaction prior to vacuum cooking and drying. In one embodiment, the extruder can be used to produce the mixture, including cooking the mixture at or above normal pressure, and dehydrating the mixture at low pressure below 1 atm, during which high and low pressures may be achieved in the extruder by degassing specific zones at specific times. In one embodiment, a specialized extruder that facilitates the mixing of the components could be used to produce the mixture, with zones for cooking the mixture, and for low-pressure drying and dehydrating of the mixture or followed by a low pressure drying and dehydrating process.

In one embodiment, the method of preparing the bioplastic includes the steps of:
a) mixing a reducing carbohydrate and an amino group-containing product and alcohol at a temperature between about 25° C. to about 145° C. until a uniform, homogenous syrup is formed; and
b) heating the mixture for about 0.25 min to about 240 min, at a temperature between about 30° C. and about 145° C. and a pressure between about 1 atm to about 70 atm in the presence of sufficient moisture so that a Maillard reaction product pellet can be formed in an amount sufficient to subsequently produce a biodegradable plastic material.

In one embodiment, the quantity of reducing carbohydrate source used in the reaction mixture can range from about 1% to about 95%, or about 5% to about 90%, or from about 20% to about 90%, or about 30% to about 80%, or about 40% to about 70%, or about 50% to about 60% based on the total weight of the mixture.

In one embodiment, the bioplastic can be formed into a film or a pellet.

In one embodiment, a biodegradable polymer is prepared by any of the methods described herein to obtain a stable biodegradable polymer.

The foregoing and other aspects of the present invention will be better appreciated by reference to the following drawing and detailed description set forth below.

### BRIEF DESCRIPTION OF THE DRAWINGS

FIG. 1 depicts the disclosed process for producing a biodegradable plastic.

### DETAILED DESCRIPTION OF THE INVENTION

The present invention addresses a long-felt need of providing a simple, reliable, and controllable Maillard process to manufacture bioplastics with superior degradation properties compared to fossil fuel-based plastics. As known in the art, when certain foods are heat-treated under moist conditions, Maillard-type reactions can occur. These reactions initially involve a condensation between the carbonyl group of a reducing sugar with the free amino group of an amino acid, protein, urea, fatty amine, or other suitable nitrogen sources, such as lactose or its hydrolysate. The result of the reaction is a Maillard reaction product.

For an industrially robust process, it has now been unexpectedly discovered that the preparation of Maillard reaction products between 95 wt % purity amino group-containing compounds and a reducing carbohydrate source (e.g., a reducing carbohydrate sugar) can be conducted and controlled by heating at moderate high pressure (about 70 atm) and drying under less than atmospheric pressure (i.e., under vacuum). When the amino group-containing compound is an amine-containing phospholipid, the phospholipid's oil is removed by a solvent extraction pretreatment. Alcohol can be added to the mixture as a plastifier.

The Maillard reaction occurs in three stages. In the initial stage, which is reversible, a colorless product, without absorption of ultraviolet light (about 280 nm) is produced through two reactions: sugar-amine condensation and Amadori rearrangement. A product of Amadori rearrangement is 1-amino-1-deoxy-2-ketose, and this product can revert back to a 6-carbon reducing sugar. In an intermediate stage, a colorless or yellow product, with strong absorption of ultraviolet light, is produced through three reactions: sugar dehydration, sugar fragmentation, and amino acid degradation (Strecker degradation). During the intermediate stage, which is irreversible, 6-carbon sugars are converted into 3-carbon sugars. In the final stage, a highly colored product is formed through two reactions: aldol condensation and aldehyde-amine condensation and formation of heterocyclic nitrogen compounds (melanoidins). If the products are overcooked, they can produce toxic acrylamides; the reaction should be stopped before reaching this point.

In the present invention, the Maillard reaction is stopped in the last stage before significant production of acrylamides. That is, the process runs through completion of Strecker degradation. As a result, the majority of the product of the Maillard reaction (e.g., 60% or more) can be melanoidins. Some of the product (e.g., 20% or less) can be unreacted reducing sugars, and some of the product (e.g., 20% or less) may be overcooked acrylamides. To control the amount of melanoidins produced, the reaction can occur under controlled time, temperature, pH, and pressure conditions. The desired product can be measured by color, smell, and specialized analytical tools, including spectrophotometry and HPLC (high-performance liquid chromatography).

As disclosed herein, a number of ranges of values are provided. It is understood that each intervening value, to the tenth of the unit of the lower limit, unless the context clearly dictates otherwise, between the upper and lower limits of that range is also specifically disclosed. Each smaller range between any stated value or intervening value in a stated range, and any other stated or intervening value in that stated range is encompassed within the invention. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included in the invention. The term “about” generally includes up to plus or minus 10% of the indicated number. For example, “about 10%” may indicate a range of 9% to 11%, and “about 20” may mean from 18 to 22. Preferably, “about” includes up to plus or minus 6% of the indicated value. Alternatively, “about” includes up to plus or minus 5% of the indicated value. Other meanings of “about” may be apparent from the context, such as rounding off, so, for example “about 1” may also mean from 0.5 to 1.4.

The ultimate bioplastic product compositions of the present invention can be in the form of dry fine powders or semi-liquids that can be blended with other solid polymers. The compositions can be made by weighing and mixing together the component quantities with up to 25% by weight of distilled water, in any equipment suitable for mixing materials. The amine-containing source and the reducing sugar are first mixed together to form a syrup. The mixture is then heated under moderate high pressure to between about 60° C. and about 95° C., preferably between about 60° C. and about 90° C., more preferably at about 85° C., at a pressure between about 40 atm, with subsequent vacuum dehydration using less than 1.0 atm, preferably at about 0.85 atm for about 7 min to about 4 hours, more preferably between about 30 and about 45 min, and then cooled to room temperature. Table 1, below, indicates the appropriate temperatures and pressures determined to be useful for the reduced pressure Maillard reaction for the formation of bioplastic followed by dehydration:

TABLE 1
Reaction conditions for Maillard synthesis
of bioplastic and dehydration

| Temperature | Pressure |
|---|---|
| (° C.) | (atm) |
| 100 | 1 |
| 95 | 0.83 |
| 90 | 0.70 |
| 85 | 0.59 |
| 80 | 0.51 |
| 75 | 0.46 |
| 70 | 0.44 |
| 65 | 0.44 |
| 60 | 0.44 |

The quantity of reducing sugar used in the reaction mixture can range from about 95 wt % to about 1 wt %, based on the total weight of the mixture such as about 95 wt %, 90 wt %, 85 wt %, 80 wt %, 75 wt %, 70 wt %, 65 wt %, 60 wt %, 55 wt %, 50 wt %, 45 wt %, 40 wt %, 35 wt %, 30 wt %, 25 wt %, 20 wt %, 15 wt %, 10 wt %, 5 wt %, 1 wt %, or any wt % therebetween. The amount used will depend on the number of reactive groups per reducing sugar molecule.

The mixture can also include up to about 25 wt % water, and can optionally include carriers, inert ingredients, and supplements to enhance the properties of the bioplastic.

A typical mix to produce a soluble bioplastic, e.g., lactose hydrolysate permeate and sugar formulation, is depicted in Table 2, together with the acceptable ranges within which individual components can be varied:

TABLE 2
Ranges of components in the bioplastic

| | International | Proportion (g/kg) | |
|---|---|---|---|
| Ingredient | Feed Number | Preferred | Range |

| | | |
|---|---|---|
| 1. Reducing carbohydrate source | 150 | 10-800 |
| 2. Amino-containing compound | 620 | 100-800 |
| 3. Low MW amino source compound | 30 | 1-300 |
| 4. Alcohol | 200 | 10-500 |

The bioplastic compositions of the present invention can also be optionally formulated with sugar sources other than hydrolyzed lactose permeate in accordance with availability and pricing of ingredients. Fructose, sucrose, high fructose corn syrup, glucose, lactose, molasses, xylose, dextrose, and spent sulfite liquor, hydrolyzed and reactive cellulose and hemicellulose as well as other reducing sugars, can be used as optional sugar sources.

In one embodiment, the ratio of reducing sugar to the amino group-containing compound is selected from one of the following weight ratios: about 1:99, about 10:90, about 20:80, about 30:70, about 40:60, about 45:55, about 50:50 about 90:10, or about 95:5. The final product embodiments according to the invention will contain one of the following quantities of melanoidins: greater than about 1 wt %, greater than about 10 wt %, greater than about 20 wt %, greater than about 30 wt %, greater than about 40 wt %, greater than about 50 wt % greater than about 60 wt %, greater than about 70 wt %, or greater than about 80 wt % of the melanoidins. Each of the foregoing embodiments include embodiments that contain less than about 90 wt %, less than about 80 wt %, less than about 70 wt %, less than about 60 wt %, or less than about 50 wt % of melanoidins.

In one embodiment, the nitrogen source for the Maillard reaction is an amino group-containing compound or compounds having a purity of at least 95 wt %. In one embodiment, the amino group-containing nitrogen source is a low molecular weight amino source compound, such as urea, amino acids such as lysine, or an oligopeptide. Bulk sources of the amino group-containing compound(s) should be de-oiled and purified to a purity of at least 95 wt % by pre-treatment to remove the oil, such as by solvent extraction. The greater the molecular weight of the amino group-containing compound(s), the more insoluble the resulting plastic will be.

In one embodiment, the nitrogen source also contains keratin in different proportions (such as those found in hydrolyzed wool or hydrolyzed feather meal).

The solubility of the bioplastic products is affected by the molecular weight of the amino groups initially used as well as the keratine content of the mixture. For example, urea-based inputs will yield more soluble plastic, whereas higher molecular weight polypeptides or more complex protein inputs (e.g., feather meal hydrolysate or wool hydrolysate) will yield more insoluble plastics.

Solubility can be controlled by blending low molecular weight nitrogen source compounds with source compounds having higher molecular weights. Single amino acids or amino groups like the ones in urea will yield a soluble plastic, while polypeptides or proteins with higher molecular weight will yield heavier and insoluble materials. For example, urea or lysine will yield a soluble polymer and hydrolysate feather meal will yield an insoluble harder polymer and combinations of the two types will yield polymers of varying solubility, and, as a consequence, varying rates of biodegradability.

Solubility can also be controlled by adding nitrogen sources that contain keratin.

As previously mentioned, a higher molecular weight carbohydrate will change solubility, so using single monosaccharides will yield a more soluble bioplastic, using more complex polysaccharides will yield stronger bioplastics with varying rates of biodegradability.

Alcohol can be added to the mix to increase the rigidity of the bioplastic. Alcohols such as glycerol can be extracted from soybean oil, methanol, butanol or ethanol. These alcohol additives play a crucial role in improving the mechanical properties and overall performance of the bioplastic, thus making it more suitable for various applications.

High molecular weight amino groups also can be obtained from green fodder products, like different grasses, forage or legumes that can be hydrolyzed into a source of amino acids or peptides and otherwise pretreated and purified to obtain the most amount of amino reacting groups. The amino groups can also be obtained from the waste of biogas fermenters that use organic matter and fermentation to obtain methane; the waste can be treated and dehydrated to obtain the most amount of reactive amino acids and peptides. The amino groups can be obtained from animal by-product hydrolysates such as bone and feather meal. Examples of such meal products include poultry meal, beef meal, and swine meal. In one embodiment, the amino groups are obtained from algae purification. In one embodiment, the amino groups are obtained from hydrolyzed wool.

Green fodder can also be hydrolyzed to obtain reactive polysaccharides and monosaccharides like cellulose and hemicellulose, glucose, fructose, fructans and other.

Different amounts of reducing carbohydrate sources or amino acid compounds are used depending on the number of reactive groups on the compounds. For this reason, more carbohydrates by weight are sometimes used, and other times more amino group-containing materials by weight are used. Therefore, as an alternative, the weight ratio of amino group-containing compound to the reducing carbohydrate source is selected from one of the following weight ratios: about 1:99, about 10:90, about 20:80, about 30:70, about 40:60, about 45:55, or about 50:50, or about 95:5, which will depend on the molecular weights of the reducing sugar and the amino group-containing compound used as well as the number of reactive amino group(s) in the amino group-containing compound(s) used in the reaction.

In one embodiment, the reducing carbohydrate is a reducing sugar. Suitable reducing sugar sources include, but are not limited to fructose, sucrose, dextrose, high fructose corn syrup, glucose, lactose, molasses, xylose, spent sulfite liquor, hydrolyzed reactive cellulose, hemicellulose obtained from grasses or legumes any other polysaccharides that can react with an amino group on an emulsifier, or mixtures of two or more thereof. The reducing sugar can be present in emulsifiers that use polysaccharides as their reactive agent. In one embodiment, the reducing sugar source is an organic hydrolysate compound, such as cheese permeate (whey) acid or sweet whey, which will provide reducing sugars like glucose or galactose via the enzymatic hydrolysis of lactose, and will also contain amino group-containing milk proteins.

In one embodiment, the mixture is heated to a temperature between about 30° C. and about 145° C. Within this range, the mixture can be heated to a range within one of the following temperature ranges: between about 30° C. and about 135° C., between about 30° C. and 95° C., between about 60° C. and 90° C., between about 60° C. and about 85° C., or between about 60° C. and about 80° C., or any temperature therebetween. The mixture can be heated to a temperature between about 40° C. and about 95° C., about 45° C. and about 90° C., about 50° C. and about 85° C., about 55° C. and about 80° C., or about 60° C. and about 75° C., or any temperature therebetween.

The heating can be performed in a reduced-pressure mixing vessel or in an extruder-mixer at elevated pressure. The pressure during extrusion-heating can be between about 1 atm and about 70 atm. The pressure can go as high as 100 atm. The pressure during low pressure cooking can range between about 0.4 atm to about 0.9 atm, and the pressure used for vacuum dehydration can range between the following pressure ranges: about 0.4 atm and about 0.9 atm, between about 0.4 atm and about 0.8 atm, between about 0.4 atm and about 0.6 atm, or between about 0.4 atm and about 0.5 atm. The pressure during low pressure cooking can be about 0.4 atm, or about 0.45 atm, or about 0.5 atm, or about 0.55 atm, or about 0.6 atm, or about 0.65 atm, or about 0.7 atm, or about 0.75 atm, or about 0.8 atm, or about 0.85 atm, or about 0.9 atm, or about 0.95 atm.

The mixture heating time can be about 0.25 min to about 120 min. In this embodiment, the mixture heating time can be selected from the following minimum heating times: a minimum of about 7 min, or about 10 min, or about 15 min, or about 20 min, or about 25 min, or about 30 min, or about 35 min, or about 40 min, or about 45 min, or about 50 min, or about 55 min, or about 60 min, or about 65 min, or about 70 min, or about 75 min, or about 80 min, or about 85 min, or about 90 min. Alternatively, the mixture heating time can be up to about 240 min, with a minimum heating time selected from the following minimum heating times: about 0.25 min, about 7 min, or about 150 min, or about 175 min, or about 200 min, or about 225 min, or about 240 min.

In one embodiment, the mixture heating time is between 0.25 seconds to about 2 hours. In another embodiment, the mixture heating time is about 45 minutes.

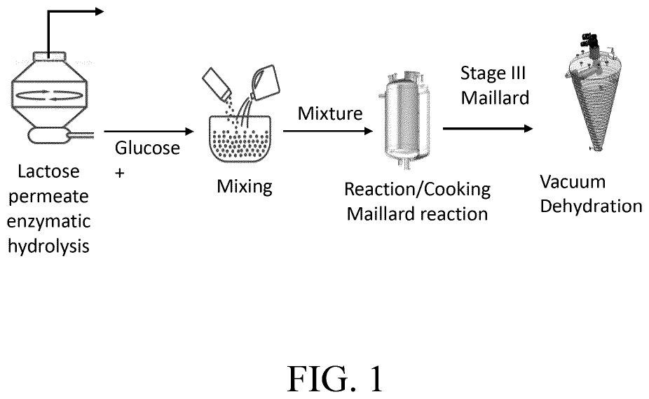

The method for preparing the Maillard reaction products can comprise a reactor or an extruder used like a biochemical reactor (a process known as reactive extrusion) to accelerate the Maillard reaction, followed by vacuum cooking (in distinct parts of the extruder) and vacuum drying. Configuration of a heated extruder that can use lower pressure conditions for purposes of performing a Maillard reaction with shear mixing under vacuum when guided by the present specification is essentially conventional to one of ordinary skill in this art. FIG. 1 shows a schematic of the processing steps used to produce the final product. First, the amino group-containing compound is mixed with a sugar (a reducing sugar), such as hydrolyzed lactose permeate. The Maillard reaction is initiated in a heated extruder, then subsequently cooked and dehydrated under vacuum, resulting in a stage III Maillard reaction compound (melanoidin).

The method of preparing a bioplastic can comprise:
a) adding alcohol;
b) mixing a reducing sugar source and amino-group containing product to provide a mixture; and
c) heating the mixture for about 0.25 min to about 120 min (alternatively, up to about 240 min), at a temperature between about 30° C. and about 145° C., at a pressure between about 1 atm and about 70 atm, in the presence of sufficient moisture so that a Maillard reaction product is formed in an amount sufficient to form a biodegradable bioplastic.

The resulting product is dried under a vacuum. The syrup formed by mixing the amino group-containing compound, the reducing carbohydrate, and the alcohol can optionally further comprise a pH adjustment agent. The pH adjustment agent can comprise a buffer. The buffer components can be selected from one or more compounds, including sodium bicarbonate, potassium dihydrogen phosphate, dipotassium hydrogen phosphate, sodium hydroxide, or phosphoric acid. The buffer can consist essentially of about 50% sodium bicarbonate, about 20% potassium dihydrogen phosphate, about 30% dipotassium hydrogen phosphate, or about 10% sodium hydroxide.

Optionally, the pH of the syrup can be adjusted from about 2 to about 11. Within this range, the pH can range between one of the following pH ranges: about 3 to about 10, about 4 to about 9, about 5 to about 8.5, about 6 to about 8.5, or about 6 to about 8. The pH can be about 2, about 2.5, about 3, about 3.5, about 4, about 4.5, about 5, about 5.5, about 6, about 6.5, about 7, about 7.5, about 8, about 8.5, about 9, about 9.5, or about 10, about 10.5, or about 11. The amount and composition of buffer required to achieve any of the foregoing pH ranges is readily apparent to one of ordinary skill in the art.

In some embodiments, enzymes are added to enhance the reaction or to unfold the polysaccharides or polypeptides to render them more reactive. Examples of suitable enzymes include, but are not limited to xylanase, β-mannanase, β-glucanase, α-galactosidase, L lactase, glucose oxidase, cellulase, neutral amylase, acid protease, neutral protease, alkaline protease, and Lipase.

Polymer products according to the present invention can be soluble, flexible or rigid, in part according to the molecular weight(s) of the compound(s) used to provide the amino group.

Methods of preparing soluble bioplastics use low molecular weight amino group-containing compounds; methods of preparing more rigid bioplastics use higher molecular weight amino group-containing products. The bioplastic can be blended with non-reactive carriers or fossil fuel-based plastics to add rigidity and integrity to the mixture. In general, the formulations can be prepared by uniformly and intimately bringing the melanoidins into association with liquid carriers, or finely divided solid carriers, or both, and then, if necessary, shaping the product.

Formulations of the invention suitable for transportation can be in the form of pellets or in syrup. The product is recovered as a pellet or film by conventional polymer processing. The syrups can be blended with higher molecular weight polymers to form them into solid biodegradable products.

The compositions of the present invention are further illustrated by the following examples. Unless otherwise specified, all starting materials and reagents are of standard commercial grade or are readily prepared from such materials by routine methods. Those skilled in the art will recognize that starting materials and reaction conditions can be varied to achieve the desired end product.

### EXAMPLES

### Example 1. Hydrolysis of Lactose in Cheese Permeate

The lactose in cheese permeate was hydrolyzed with enzymes as known in the art to yield glucose and galactose. In one embodiment, the hydrolysis takes place at pH 6.5 and at about 40° C. over about 3 hours. The permeate, which usually comprises about 80% water, was dehydrated by membrane processing to yield a product comprising about 50% water.

### Example 2. Typical Preparation of the Bioplastic

The hydrolyzed and concentrated lactose permeate of Example 1 was mixed according to Table 3 (below) with an amino group-containing source, such as urea, so that the bioplastic has greater solubility. The mixture was heated at about 85° C. for about 2 hours under vacuum (about 0.85 atm) until the water evaporated, resulting in the bioplastic.

TABLE 3
Percentages of components of biodegradable bioplastic

| Component | % as mixed |
|---|---|
| Lactose hydrolysate | 76.9 |
| UREA | 3.8 |
| Maltodextrin | 18.8 |
| NaOH | 0.4 |

### Example 3. Different Compositions of Bioplastic with Variable Consistencies

Example bioplastic compositions with varying consistencies and solubilities are provided. All mixtures were similarly prepared via heating for up to about four hours (Product C) in a vacuum oven until there was complete moisture evaporation. Product C (from Example 2) represents an ideal bioplastic composition.

TABLE 4
Variable compositions of biodegradable bioplastics.

Formulation

| | A | B | C | D |
|---|---|---|---|---|
| Component | % | % | % | % |
| Lactose hydrolysate 20% DM | 55.6 | 68.2 | 76.9 | 76.9 |
| UREA | 3.3 | 3.6 | 3.8 | 5.8 |
| Maltodextrin | 40.6 | 27.7 | 18.8 | 16.9 |
| NaOH | 0.6 | 0.5 | 0.4 | 0.4 |

### Example 4. Preparation of Film-Forming Dispersions Using a Mix of Feather Meal Hydrolysate, Lactose, and Glycerol

A 0.1M NaOH was prepared and 10% (w/w) feather meal was added. The dispersion was mixed using a homogenizer for 40 minutes at room temperature. Then the lactose and glycerol were added as described in Table 2. Water was added to the mixture to maintain the desired initial water content and ensure consistent mechanical properties of the final film products.

The mixtures were transferred to a container and heated at 90° C. for 1 hour to initiate the Maillard reaction, Then the mixtures were transferred to an oven and heated at 50° C. The dispersion was allowed to dry for around 8 hours, which enabled the formation of a film.

The films were removed from the trays or surfaces they were dried on once the drying process was complete. The films were allowed to cool down to room temperature and then stored in a chamber with controlled humidity. In this case, a humidity of 44% is achieved by using saturated potassium carbonate. The films were stored in the controlled humidity chamber for 48 hours at room temperature. These steps result in films with desired properties for further mechanical property measurements.

TABLE 5
Different mixtures of bioplastic using
feather meal as the amino donor.

| Sample | Control | Mix 1 | Mix 2 | Mix 3 |
|---|---|---|---|---|
| Mass (g) of 10% Feather | 200 | 190 | 170 | 130 |
| meal hydrolysate solution | | | | |
| Lactose (g) | 0 | 1 | 3 | 7 |
| Glycerol (mL) | 6 | 5.7 | 5.1 | 3.9 |
| Water (g) | 0 | 10 | 27 | 63 |

Several rheology tests were performed on the control and the sample mixtures. The results are described in Table 6.

TABLE 6
Rheology tests performed.

| | | | Maximum | Tensile | Modulus |
|---|---|---|---|---|---|
| | Maximum | Force | tensile | strength | of |
| | force | at break | strength | at break | elasticity |
| Sample | (N) | (N) | (MPa) | (MPa) | (MPa) |
| Control | 15.84 | 14.59 | 2.99 ± 0.26* | 2.75 ± 0.29* | 133.93 ± |
| | | | | | 19.54* |
| Mix 1 | 18.7 | 17.83 | 3.66 ± 0.44* | 3.50 ± 0.51* | 179.86 ± |
| | | | | | 33.89* |
| Mix 2 | 13.18 | 11.79 | 2.40 ± 0.70* | 2.17 ± 0.84* | 124.48 ± |
| | | | | | 48.89* |
| Mix 3 | 8.49 | 6.03 | 1.73 ± 0.39* | 1.80 ± 0.77* | 126.76 ± |
| | | | | | 29.02* |

| | Elongation | Moisture |
|---|---|---|
| Sample | at break (%) | content (%) |
| Control | 48.52 ± 6.65* | 15.54 |
| Mix 1 | 18.22 ± 7.47* | 15.99 |
| Mix 2 | 16.50 ± 6.13* | 16.62 |
| Mix 3 | 3.79 ± 0.59* | 20.06 |

Note:
*p < 0.05

As can be seen in Table 6, mix 1 was the best mix in terms of rheology parameters.

### Example 5. Digestibility Parameters of Mix 1 Fermentation Parameters of Mix 1

Mix 1 was prepared as described in Example 4. An uncooked sample and a cooked sample were fermented in an Ankom Daisy II incubator, 120V 50/60 Hz machine. Disappearance of the samples from Dacron® filter bags indicating digestibility was measured in vitro as described by Goering and Van Soest (Goering and Van Soest. Forage fiber analyses (apparatus, reagents, procedures, and some applications). 1970. Agric. Handbook No. 379. ARSUSDA, Washington, DC.).

TABLE 7
Uncooked vs. cooked bioplastics.

| | Uncooked | Cooked |
|---|---|---|
| | bioplastic | bioplastic |
| Digestibility | 84% | 55% |

The results in Table 7 show that the digestibility of cooked bioplastic decreased compared to uncooked bioplastic. However, despite the increase in digestibility, the cooked bioplastic retained a digestibility value of 55%. This percentage suggests that the cooked bioplastic can still be utilized as feed for ruminants. The fact that it remained suitable for ruminant feed even after cooking indicates that it could serve as a viable energy and protein source for use in the agricultural industry.

While certain embodiments of the present invention have been described and specifically exemplified above, it is not intended that the invention be limited to such embodiments. Various modifications may be made thereto without departing from the scope and spirit of the present invention as set forth in the following claims. All such modifications coming within the scope of the present claims are intended to be included herein.

We claim:

1. A method of preparing biodegradable melanoidin polymers of varying solubility from non-fossil fuel-based ingredients, said method comprising at least the following steps:
a) mixing by application of shear force a quantity of a reducing carbohydrate source and a quantity of an amino group-containing compound to provide a mixture of said reducing carbohydrate source and amino group compounds, wherein neither the carbohydrates nor the amino acid group compounds are isolated from fossil fuels;
b) heating the mixture for a sufficient amount of time at a sufficient temperature and pressure with sufficient moisture so that a Maillard reaction occurs between the amino groups and the reducing carbohydrate source sufficient to provide a Maillard reaction product that will effectively yield a biodegradable bioplastic;
c) stopping the reaction before it proceeds significantly beyond the melanoidin-formation steps of the Maillard reaction to limit the formation of acrylamides; and
d) vacuum-dehydrating the bioplastic reaction product under reduced (sub-atmospheric) pressure.

2. The method of claim 1, wherein the method further comprises adding a quantity of alcohol to the mixture of step a).

3. The method of claim 2, wherein the alcohol is added to the mixture of said reducing carbohydrate source and amino group compounds at a ratio of about 5:95, about 10:90 or about 30:70.

4. The method of claim 1, wherein the bioplastic can be fed to ruminant animals or biodigesters.

5. The method of claim 1, wherein the quantity of the reducing carbohydrate source is less than the quantity of the amino group-containing compound.

6. The method of claim 1, wherein the quantity of the reducing carbohydrate source is greater than the quantity of the amino group-containing compound.

7. The method of claim 5, wherein the quantity of the reducing carbohydrate source and the amino group-containing compound is in an amount by weight.

8. The method of claim 1, wherein the amino group-containing compound comprises an amino acid, protein, urea, fatty amine, or other suitable nitrogen source.

9. The method of claim 1, wherein the amino group-containing compound comprises keratin.

10. The method of claim 1, wherein the reducing carbohydrate source comprises hydrolyzed lactose permeate, fructose, sucrose, high fructose corn syrup, glucose, lactose, molasses, xylose, dextrose, maltodextrin, spent sulfite liquor, any other polysaccharides that can react with an amino group on an emulsifier, or mixtures of two or more thereof.

11. The method of claim 7, wherein the reducing carbohydrate source can be present in emulsifiers that use polysaccharides as their reactive agent.

12. The method of claim 1, wherein the ratio of reducing carbohydrate source to amino group-containing compound is selected from one of the following weight ratios: about 1:99, about 10:90, about 20:80, about 30:70, about 40:60, about 45:55, 50:50, or about 95:5.

13. The method of claim 1, wherein the weight ratio of amino group-containing compound to the reducing carbohydrate source is selected from one of the following weight ratios: about 1:99, about 10:90, about 20:80, about 30:70, about 40:60, about 45:55, about 50:50, or about 95:5.

14. The method of claim 1, wherein the mixture is heated to a temperature between about 60° C. and about 135° C., or between about 60° C. and about 120° C., or between about 60° C. and about 80° C.

15. The method of claim 7, wherein the pressure during the heating step can be between about 1 atm and about 100 atm.

16. The method of claim 7, wherein the pressure during the dehydrating step can be between about 0.4 atm and about 0.9 atm, or between about 0.4 atm and about 0.6 atm, or between about 0.4 atm and about 0.5 atm.

17. The method of claim 1, wherein the mixture heating time can vary from about 0.25 min to about 240 min.

18. The method of claim 1, wherein the method of preparing the biodegradable plastic can comprise a reactor or an extruder used like a biochemical reactor to accelerate the Maillard reaction prior to cooking and vacuum drying.

19. The method of claim 18, wherein the extruder may be used to produce the mixture, including cooking the mixture at or above normal pressure, and dehydrating the mixture at low pressure below 1 atm, during which high and low pressures may be achieved in the extruder by degassing specific zones at specific times.

20. The method of claim 1, wherein the method of preparing the bioplastic includes the steps of:
a) mixing a reducing carbohydrate and an amino group-containing product and alcohol at a temperature of about 25° C. until a uniform, homogenous syrup is formed; and
b) heating the mixture for about 0.25 min to about 240 min, at a temperature between about 30° C. and about 145° C. and a pressure between about 1 atm and about 70 atm in the presence of sufficient moisture so that a Maillard reaction product pellet can be formed in an amount sufficient to subsequently produce a biodegradable plastic material.

21. The method of claim 17, wherein the quantity of reducing carbohydrate source in the reaction mixture can range from about 1% to about 95%, or about 5% to about 90%, or about 20% to about 90%, or about 30% to about 80%, or about 40% to about 70%, or about 50% to about 60% based on the total weight of the mixture.

22. The method of claim 1, wherein the mixture is heated at reduced pressure below 1 atm.

23. A biodegradable polymer prepared by the method of claim 1.
